(19) United States
(12) Patent Application Publication
(10) Pub. No.: US 2020/0218444 A1
(43) Pub. Date: Jul. 9, 2020

(54) Mode of Transportation, User Interface and Method for Operating a User Interface

(71) Applicant: Bayerische Motoren Werke Aktiengesellschaft, Muenchen (DE)

(72) Inventor: Julian EICHHORN, Menlo Park, CA (US)

(21) Appl. No.: 16/824,194

(22) Filed: Mar. 19, 2020

Related U.S. Application Data
(63) Continuation of application No. PCT/EP2018/075217, filed on Sep. 18, 2018.

(30) Foreign Application Priority Data
Oct. 9, 2017 (DE) 10 2017 217 914.7

(51) Int. Cl. G06F 3/0488; G06F 3/0481; B60K 35/00

(52) U.S. Cl. CPC G06F 3/04886; G06F 1/1692; B60K 35/00; G06F 3/04817

(57) ABSTRACT

A mode of transportation, a user interface, and a method for operating a user interface are disclosed. The user interface includes a first display device, a second display device, and an evaluator. The method includes displaying a plurality of command buttons, which are allocated to a screen display on the first display device. On the second display device, the method includes automatically determining on the basis of an incoming signal that an ergonomic optimization of an arrangement of the associated command buttons is possible. The arrangement is automatically optimized in response to the determination.

### CROSS REFERENCE TO RELATED APPLICATIONS

This application is a continuation of PCT International Application No. PCT/EP2018/075217, filed Sep. 18, 2018, which claims priority under 35 U.S.C. § 119 from German Patent Application No. 10 2017 217 914.7, filed Oct. 9, 2017, the entire disclosures of which are herein expressly incorporated by reference.

### BACKGROUND AND SUMMARY OF THE INVENTION

The present subject matter relates to a user interface, a method for operating a user interface and a mode of transport equipped with such a user interface. The present invention relates to ergonomic improvements for user interfaces that have a touch-sensitive surface of at least one monitor (touchscreen) that the user interface contains.

Modern modes of transport now contain a multiplicity of screens that from time to time are also embodied as a touchscreen (touch-sensitive screen). These involve different philosophies and configurations being pursued. The screens are used for the input and/or output of information by or to a user. By way of example, touchscreens are used within the reach of the user. For input, rotary push controls within reach are moreover also used in combination with a monitor arranged further away from the user. From time to time, touchpads (touch-sensitive surfaces) without a display behind are also used in combination with a screen arranged at a distance from the user. Joysticks have also been proposed for use within the reach of a user of a mode of transport in combination with a screen.

DE 10 2005 023 963 A1 discloses a mobile communication device, in which a weighting is determined on the basis of the frequency of use/period of use of information, as a result of which contacts presented in a list are more easily usable as what are known as “top contacts” for the user on the basis of their frequency of use.

Such direct-touch operation on a touchscreen, which involves the user manipulating objects and performing actions directly on a touch-sensitive screen, is usually perceived as optimum and intuitive. A touchscreen in a vehicle should thus be positioned ergonomically within reach. Unfortunately, this means that the display thereon is too close to the observer to be easily accommodated. Changing one's eyes from the road to the touchscreen is problematic or demanding. Arrangements that separate the display and the operation are unfortunately less intuitive because they are perceived as unnatural.

Buttons should moreover be presented on a screen situated close to the user such that manipulation/operation of the buttons is possible with as little or as intuitive operation as possible. At best, this means that the user can touch that position at which the desired button is situated without having to look at the button. In this way, he is at best able to operate the touch-sensitive surface blind.

Against the background of the aforementioned prior art, it is an object of the present subject matter to render operation of a touch surface or of a user interface comprising a touch surface easier, more ergonomic and more intuitive.

The aforementioned object is achieved according to the present subject matter by a method for operating a user interface. The user interface can be in a mode of transport. The user interface may be installed permanently in the vehicle. The user interface comprises a first display device and a second display device. The display devices, at least one of the display devices, can be embodied as screens. The second display device comprises a touch-sensitive surface in order to accept touch inputs from the user. The display devices can be arranged in different planes/screen planes. The first display device can be further away from the user than the second display device. Whereas the first display device can thus be suitable for displaying information and, to produce an attractive visual appearance for the user interface, can be arranged slightly further away from the user and inset in a peripheral area, the second display device having the touch-sensitive surface is intended for interaction for the user or acceptance of user inputs. According to the present subject matter, information is displayed on the first display device in a screen display/screen view that has an associated multiplicity of buttons that are presented on the second display device. The buttons are thus used for example to access elements and/or information and/or functions displayed on the first display device. The buttons can fill substantially predominant surface regions of the second display device. The display area of the second display device can be substantially taken up by the multiplicity of associated buttons. Preferably, there is provision for dividing lines just a few pixels wide between the buttons. This allows the individual button to be touched more easily by the user. Operating errors can therefore be avoided. To further improve the ergonomics of the user interface according to the present subject matter, it is subsequently automatically ascertained, on the basis of an arriving signal, that ergonomic optimization of an arrangement of the associated buttons is possible. In other words, optimization potential for the ergonomics of the presented buttons is ascertained by the arriving signal for at least one user. In response thereto, the arrangement of the buttons is automatically optimized. By way of example, the arriving signal can take the user interface from a first operating state into a second operating state. While a previous arrangement of the buttons in the previous operating state may already have been able to be denoted as optimum, the subsequent operating state reveals the buttons arranged in a manner updated according to the present subject matter to be optimum. In other words again, the operating state of the user interface according to the present subject matter changes as a result of the arrival of the signal such that altered ergonomic demands are placed on the user interface after the signal has arrived. On the basis of predefined criteria for the subsequent operating state, the arrangement of the buttons is subsequently automatically optimized. Both before and after the arrival of the signal, an automatically optimized button arrangement is created, which always achieves the best possible assistance for the user.

The signal can be generated, for example, in response to an incoming data connection. In other words, an incoming telephone call, an incoming text message, an incoming MMS, an incoming e-mail or a report from an application of the user interface can be responsible for the signal or understood as triggering that signal, without the signal being restricted to one of the aforementioned applications. Alternatively or additionally, a system report can be responsible for the signal being generated. By way of example, an operating state of the user interface or of a mode of transport associated therewith can change, in response to which the signal is automatically generated. By way of example, an energy reserve of the mode of transport can draw to an end, in response to which the driver or another user needs to decide how to ensure that traction energy is received in good time. The aforementioned events can be reacted to more ergonomically and hence with less potential for distraction by the user by virtue of the automatic optimization of the arrangement of the buttons. The user acceptance of a user interface according to the present subject matter is improved by a method according to the present subject matter.

By way of example, the signal can represent an increased frequency of use of a button from the multiplicity of buttons in comparison with other buttons from the multiplicity of buttons. In other words, a button can be operated by the user using the touch-sensitive surface of the second display device, as a result of which e.g. an applicable counter is increased and in any case an increased frequency of use of this button is documented. In order to ergonomically optimize future operation of the button further, the button can subsequently be highlighted at an altered position and alternatively or additionally by virtue of an increased presentation size in comparison with the remaining multiplicity of buttons. This improves usability or use ergonomics in the button once more, so that the use ergonomics of the user interface according to the present subject matter are correspondingly increased with a high probability of increased frequency of use of the button for the future, too.

The altered positioning of the button can have a positive effect on use ergonomics if the button is at a position that is easily and/or repeatedly touchable by the user. The position can be close to the driver's seat of a driver if the user is the driver of a mode of transport. The same can apply to the button if the user is a front-seat passenger in a mode of transport. For left-hand drive vehicles, this means that a button on a second display device arranged in the central console can be assumed to be ergonomically optimized for the driver for example if the button is presented in the region of a left-hand screen half. The same applies to a right-hand screen half and the front-seat passenger in the mode of transport. The circumstances are accordingly converse for a right-hand drive vehicle. In this regard, the current user and/or his position can be detected by sensor and the optimization according to the present subject matter can be achieved using a correspondingly suitable arrangement of the buttons.

To allow easy confirmation of a system report or of other events by the user, the position of a finger of a user in a region in front of the second display device can be ascertained without actual contact with the touch-sensitive surface. By way of example, an infrared camera or another suitable sensor for detecting a three-dimensional position of a finger of the user in space can be used for this purpose. The optimization can then be effected such that a button in the ascertained position that will most likely be operated by the user is presented as near as possible on the second display device.

The optimization of the presentation of the buttons on the second display can remain without influence on the screen display of the first display device. In other words, the second display device is not a reflection or duplication of a content of the first display device. By way of example, the content presented on the first display device can be presented independently of a position/identity of the current user, while the above-described ergonomic improvement by the second display device can take into consideration a position of the user. An identical display content on the first display device may thus be associated with two completely different arrangements of buttons on the second display device if a (e.g. user-dependent) ergonomic improvement or personal preferences of the users are accordingly predefined. In other words, a function for which one and the same screen display is always presented on the first display device independently of the user can be rendered accessible/manipulable on the basis of the user by two different screen displays and button arrangements on the second display device. It is possible for the arriving signal to have an influence on the screen display of the first display device. Alternatively or additionally, an additional display level can be overlayed (e.g. semitransparently or the like) on the previous screen display. A system report and/or a representation of an incoming data connection can be displayed on the additional display level. An altered positioning and/or an altered relative presentation size of one of the multiplicity of buttons or of multiple instances of the multiplicity of buttons then allows the ergonomics of the user interface according to the present subject matter to be automatically optimized according to the present subject matter. The button associated with the system report can then be highlighted in terms of its size and/or color and/or position and/or other appearance in comparison with other buttons from the continually presented multiplicity of buttons to produce the ergonomic improvement.

The first display device and/or the second display device can be rendered ambient (i.e. transparent and/or translucent), so that they do not appear as black tiles in the off or empty state. This allows the display and operation of a screen control system in the vehicle to be rendered ergonomic and integrated in a manner suited to the design.

In accordance with a second aspect of the present subject matter, a user interface is proposed that has a first display device, an evaluator, and a second display device. The second display device has a touch-sensitive surface via which the content presented thereon can be manipulated. The user interface is thus configured to carry out a method in accordance with the first-mentioned aspect of the present subject matter. The features, combinations of features and advantages of the user interface according to the present subject matter thus arise in a corresponding manner from the above remarks pertaining to the method according to the present subject matter in such an obvious manner that reference is made to said remarks to avoid repetition.

In accordance with a third aspect of the present subject matter, a mode of transport is proposed that has a user interface in accordance with the second-mentioned aspect of the present subject matter. In this instance, the first display apparatus can be at a greater distance than the second display device from a backrest of a driver's seat and/or of a front-seat passenger's seat of the mode of transport. In other words, the first display apparatus is preferably situated in a plain viewing area, while the second display apparatus is preferably additionally situated in an interaction area/manual area/within reach of the respective user. By way of example, the first display device can be integrated in a dashboard of the mode of transport. The second display device can be integrated in a central console of the mode of transport. Independently of the respective aspect of the present subject matter, the first display device can have a screen normal that is at a smaller angle from the horizontal than a screen normal of the second display device. In other words, the first display device can be arranged more steeply in the mode of transport than the second display device. As a result of the second display device having a better/more comfortable support surface for the finger/hand of the user, it is ergonomic/effortless for the finger/hand of the user to stay on the second display device. The screen of the second display device can be arranged substantially horizontally, whereas the first display device has a screen that is arranged substantially vertically.

Other objects, advantages and novel features of the present subject matter will become apparent from the following detailed description of one or more preferred embodiments when considered in conjunction with the accompanying drawings.

### BRIEF DESCRIPTION OF THE DRAWINGS

FIG. 1 shows a schematic side view of an example embodiment of a mode of transport according to the present subject matter with an example embodiment of a user interface according to the present subject matter.

FIG. 2 shows a perspective depiction of a driver workstation in an example embodiment of a mode of transport according to the present subject matter using an example embodiment of a user interface according to the present subject matter.

FIGS. 3-6 show views of screen content of two display apparatuses of an example embodiment of a user interface according to the present subject matter, as has been presented in conjunction with FIGS. 1 and 2.

FIG. 7 shows a flowchart illustrating steps of an example embodiment of a method according to the present subject matter.

### DETAILED DESCRIPTION OF THE DRAWINGS

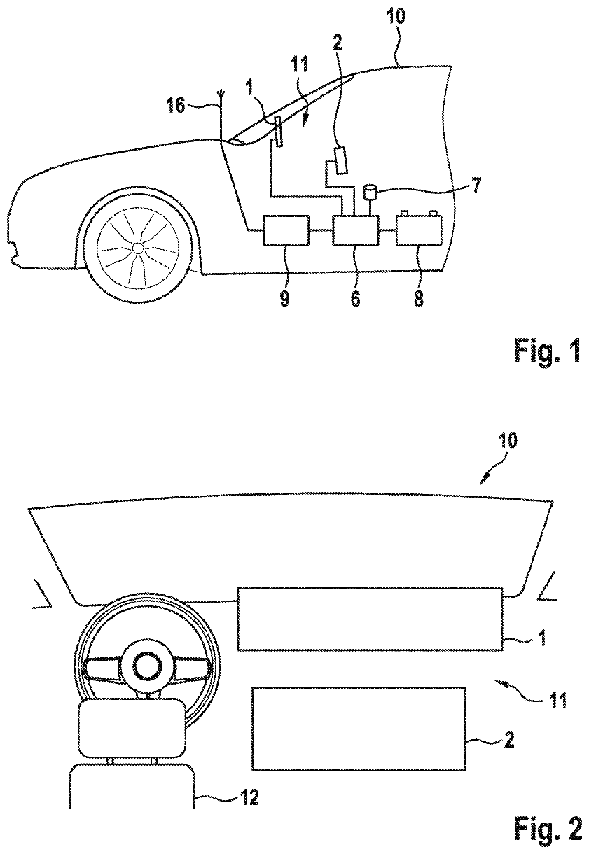

FIG. 1 shows an automobile 10 as a mode of transport, which has a battery 8 as traction energy store. The battery 8 is connected to an electronic controller 6 as evaluator. The electronic controller 6 is moreover connected to a data memory 7 for information interchange purposes. A first screen 1 arranged in the dashboard as first display device is linked to the electronic controller 6 for information interchange purposes, just like a second screen 2 arranged in the central console as second display apparatus. The screens 1, 2 in combination with the electronic controller 6 are an example embodiment of a user interface 11 according to the present subject matter. The electronic controller 6 is moreover connected for information interchange purposes to a telephony module 9, via which it can receive signals received by an antenna 16 for incoming data connections. If, for example, a telephone call comes in, an appropriate message can be presented by the first screen 1 and a corresponding input by a button using the second screen 2 can be accepted from the user. By way of example, the user can reject or take the call. This can be effected on the basis of a caller identifier, for example. If the caller is usually rejected by the user, an ergonomic improvement can be ensured by virtue of the button for rejecting the call being presented at an ergonomically more significant position on the second screen 2 than the button for taking the call. The correspondingly opposite applies to the case in which the user usually takes the incoming caller instead of rejecting him. This can moreover take place automatically on the basis of the time of day, date, calendar entries for the user, operating state of the mode of transport, etc. If for example the electronic controller 6 ascertains that the traction energy stored in the battery 8 holds a remaining range below a predefined reference, an associated system report can be presented on the first screen 1, and different measures can be offered on the second screen 2 such that recommendable inputs, which thus have a high probability of being made, are assisted by buttons at those positions on the second screen 2 that can be accessed easily and ergonomically by the user (not depicted).

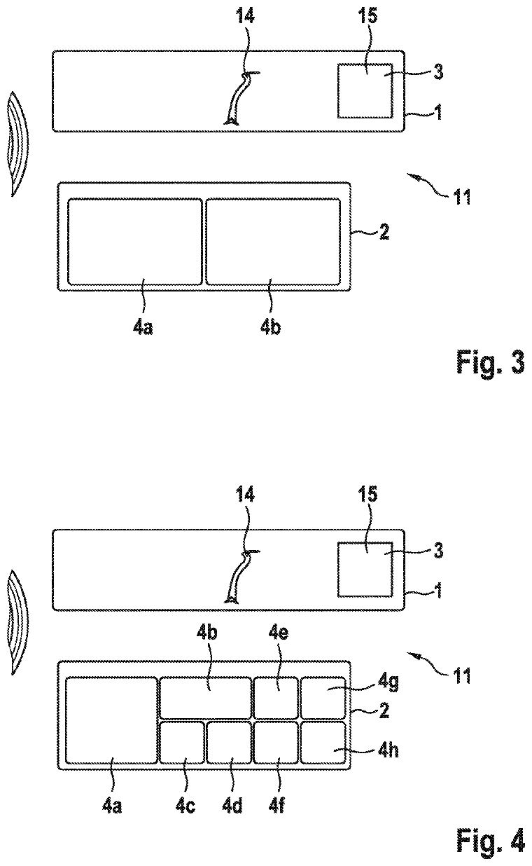

FIG. 2 shows a perspective depiction of a driver workstation, which is presented in a side view in FIG. 1 and in which the first screen 1 is at a greater distance from the backrest of a driver's seat 12 than a second screen 2 of the user interface 11 according to the present subject matter. The first screen 1 is thus suitable for presenting information, while the second screen 2 (configured as a touchscreen) is suitable for accepting ergonomically made user inputs.

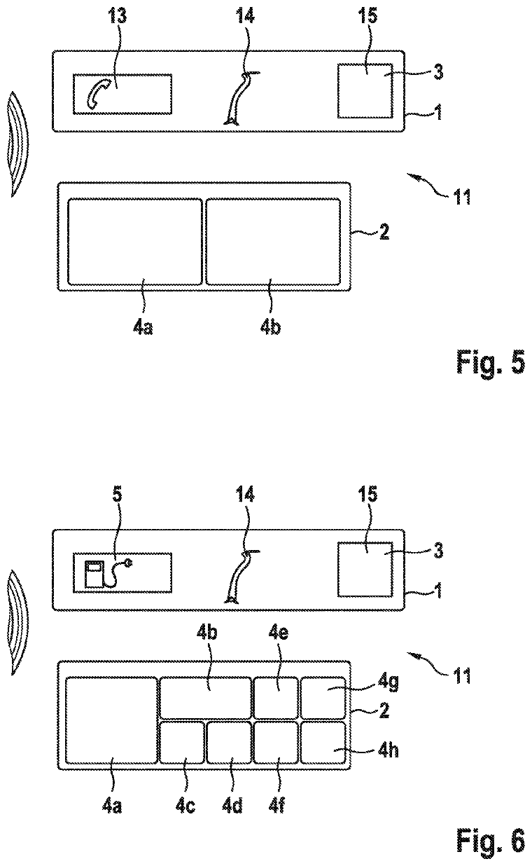

FIG. 3 shows a first screen 1 with a screen display that comprises, beside time and data statements and standard statements from an onboard computer, graphics representing a route profile 14 ahead and an album cover 15. The screen display 3 of the first screen 1 can be operated using a first button 4a and a second button 4b on a second screen 2 of an example embodiment of a user interface 11 according to the present subject matter. The buttons 4a, 4b take up more than half, preferably more than two thirds, of the overall presentation area of the second screen 2. Even when operating blind, it is thus comparatively improbable that the buttons 4a, 4b will be missed by the user. The presentation size of the buttons 4a, 4b is identical, since the functions associated with the buttons 4a, 4b were selected by the user with the same probability according to a previous history.

FIG. 4 shows the arrangement depicted in FIG. 3 for the case in which the buttons 4a to 4h relating to the screen display 3 were operated with greatly different probability by the user to date. By way of example, the button 4a is proportioned such that it takes up four divisions of the button grid, since the user has used the button 4a thirty-four times to date. The button 4b occupies two divisions of the button grid that are arranged next to one another, since it has been operated twenty-eight times. The remaining buttons 4c to 4h are each proportioned identically with one button division, in order to correspond to the respective frequencies of operation (once to twelve times). If the relative frequency of use of the button 4c as compared with the button 4b increases with the future use by the user, the button 4c could displace the button 4d upward, as a result of which the button 4b is reduced to a single button division, this makes space for the button 4d and the button 4c can “spread out” by one button division to the right. In this way, operation of the button 4c, which is now used more frequently, would become more ergonomic for the user.

FIG. 5 shows the configuration depicted in FIG. 3 following the arrival of a telephone call, which is signaled visually by a text message 13 overlaid on the previous screen display 3. Since the current occupancy state of the automobile has been detected by sensor, the user interface according to the present subject matter knows that the user is alone in the mode of transport. A use history of this user in conjunction with incoming calls from the caller furthermore states that the user tends to accept the calls from the caller and therefore the button 4a has been put into an ergonomically favorable position. To reject the incoming call, the user would need to operate the button 4b, which is at a greater distance from the driver's seat 12.

FIG. 6 shows the configuration depicted in FIG. 3, according to which it has been established that the remaining electrical range of the mode of transport has fallen to fifty kilometers. This is presented on the first screen 1 by a text message 5. The points of interest (important points in the surroundings, attractions) represented by buttons 4a to 4h on the second screen 2 are re-sorted or rearranged in response thereto such that, according to the increased need for traction energy, the applicable button 4a is presented not only in as large a manner as possible but also nearest to the user. In other words, a button 4a previously presented further to the right and/or in reduced fashion can, in response to a predefined range threshold being reached, be favored over other buttons 4b to 4h by virtue of its distance from the user being reduced and its relative size in comparison with the other buttons 4b to 4h being increased.

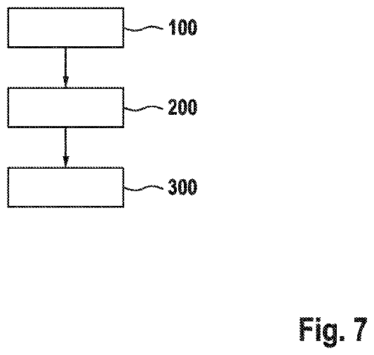

FIG. 7 shows steps of an example embodiment of a method according to the present subject matter for operating a user interface. The user interface comprises a first display device and a second display device. The second display device has a touch-sensitive surface that configures it as a touchscreen. In step 100 of the method, a multiplicity of buttons associated with a screen display on the first display device are displayed on the second display. The buttons are used for a user interaction with the scopes of functions of the user interface that are represented by the screen display. In step 200, it is automatically ascertained, on the basis of an arriving signal, that ergonomic optimization of an arrangement of the associated buttons is possible. In response thereto, the arrangement of the buttons on the second display device is automatically optimized in step 300, so that ergonomic operation of such buttons as extremely probably need to be operated by the user is favored.

Ultimately, road safety when using a user interface according to the present subject matter in a mode of transport is increased. The potential for distraction for the user by the user interface is reduced in comparison with arrangements known in the prior art. By this means, the user acceptance of a user interface is increased in accordance with the present subject matter.

### LIST OF REFERENCE SIGNS

1 First screen
2 Second screen (with touch-sensitive surface)
3 Screen display
4 4a to 4h buttons
5 Text message
6 Electronic controller
7 Data memory
8 Battery
9 Telecommunication module
10 Automobile
11 User interface
12 Driver's seat
13 Text message
14, 15 Graphics
16 Antenna
100-300 Method steps

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating a user interface using a first display device and a second display device having a touch-sensitive surface, the method comprising:
displaying a multiplicity of buttons on the second display device, said buttons being associated with a screen display on the first display device;
automatically ascertaining, on the basis of an arriving signal, that ergonomic optimization of an arrangement of the associated buttons is possible; and
automatically optimizing the arrangement in response to the automatic ascertaining.

2. The method according to claim 1, wherein
the arriving signal is generated in response to an incoming data connection or a system report.

3. The method according to claim 2, wherein
the incoming data connection represents:
an e-mail;
a telephone call; and/or
a report from an application of a vehicle electrical system or of a mobile communication device connected to the vehicle electrical system for data interchange purposes.

4. The method according to claim 1, wherein
the signal represents an increased frequency of use of a button of the multiplicity of buttons by the touch-sensitive surface in comparison with other buttons of the multiplicity of buttons.

5. The method according claim 1, wherein
the automatic optimizing of the arrangement on the second display apparatus necessitates:
altered positioning; and/or
altered relative presentation size of the multiplicity of buttons.

6. The method according to claim 1, wherein
the signal relates to a button that is subsequently presented closer to a position of a user on the basis of the automatic optimizing.

7. The method according to claim 1, wherein
the automatic optimizing remains without influence on the screen display on the first display apparatus.

8. A user interface, comprising:
a first display device;
an evaluator;
a second display device having a touch-sensitive surface, wherein
the user interface is configured to:
display a multiplicity of buttons on the second display device, said buttons being associated with a screen display on the first display device;
automatically ascertain, on the basis of an arriving signal, that ergonomic optimization of an arrangement of the associated buttons is possible; and
automatically optimize the arrangement in response to the automatic ascertaining.

9. The user interface according to claim 8, wherein
the arriving signal is generated in response to an incoming data connection or a system report.

10. The user interface according to claim 9, wherein
the incoming data connection represents:
an e-mail;
a telephone call; and/or
a report from an application of a vehicle electrical system or of a mobile communication device connected to the vehicle electrical system for data interchange purposes.

11. The user interface according to claim 8, wherein
the signal represents an increased frequency of use of a button of the multiplicity of buttons by the touch-sensitive surface in comparison with other buttons of the multiplicity of buttons.

12. The user interface according claim 8, wherein
the automatic optimizing of the arrangement on the second display apparatus necessitates:
altered positioning; and/or
altered relative presentation size of the multiplicity of buttons.

13. The user interface according to claim 8, wherein
the signal relates to a button that is subsequently presented closer to a position of a user on the basis of the automatic optimizing.

14. The user interface according to claim 8, wherein
the automatic optimizing remains without influence on the screen display on the first display apparatus.

15. A mode of transport comprising:
a user interface, comprising:
a first display device;
an evaluator;
a second display device having a touch-sensitive surface, wherein
the first display device is at a greater distance than the second display device from a backrest of a driver's seat of the mode of transport.

16. The mode of transport according to claim 15, wherein
the first display device is arranged in a dashboard; and
the second display device is arranged in a central console of the mode of transport.
